(19) United States
(12) Patent Application Publication
(10) Pub. No.: US 2016/0228986 A1
(43) Pub. Date: Aug. 11, 2016

(54) METHOD AND LASER ASSEMBLY FOR PROCESSING A WORK PIECE USING A PULSED LASER BEAM

(71) Applicant: ROFIN-BAASEL LASERTECH GMBH & CO. KG, Starnberg (DE)

(72) Inventors: JAN KASTER, STARNBERG (DE); FLORIAN SOTIER, MUENCHEN (DE); FRED-WALTER DEEG, SCHLIERSEE (DE); STEPHAN GEIGER, HEBERTSHAUSEN (DE)

(21) Appl. No.: 15/055,811

(22) PCT Filed: Jul. 29, 2014
(86) PCT No.: PCT/EP2014/066270

§ 371 Date: Feb. 29, 2016

(30) Foreign Application Priority Data
Aug. 30, 2013 (DE) 10 2013 109 479.1

(51) Int. Cl. B23K 26/0622; B23K 26/073; B23K 26/00

(52) U.S. Cl. CPC B23K 26/0624; B23K 26/0066; B23K 26/073

(57) ABSTRACT

A method and a laser assembly process a work piece using a pulsed laser beam. In the method, during processing the lateral distribution of the spectral phase is varied non-linearly over the duration of a laser pulse and/or at least between two laser pulses that at least partially overlap on the work piece.

### CROSS-REFERENCE TO RELATED APPLICATION

This is a continuation application, under 35 U.S.C. §120, of copending international application No. PCT/EP2014/066270, filed Jul. 29, 2014, which designated the United States; this application also claims the priority, under 35 U.S.C. §119, of German patent application DE 10 2013 109 479.1, filed Aug. 30, 2013; the prior applications are herewith incorporated by reference in their entireties.

### BACKGROUND OF THE INVENTION

### Field of the Invention

The invention relates to a method and to a laser assembly for processing a work piece using a pulsed laser beam.

Published, non-prosecuted German patent application DE 103 33 770 A1, corresponding to U.S. Pat. No. 7,989,731, discloses a method for processing a work piece using a pulsed laser beam.

When processing a work piece using a pulsed laser beam, the laser pulses of which have pulse durations of less than 20 ps and are in particular in the femtosecond range, phenomena occur that cannot be observed when using laser pulses having longer pulse durations. If material removal is carried out with such ultra short laser pulses, it is possible that structures, so-called nano-ripples, appear on the processed surface of the work piece, which structures are spaced apart from one another approximately in the order of magnitude of the wavelength used. These structures are caused by interference between incoming and outgoing radiation and the interaction with the solid body. The incoming radiation interacts first with the electrons in the solid body and produces density fluctuations of the surface-near electrons (plasmon polariton interaction). Reflected radiation components can here be additionally modulated by the density fluctuations that are excited in this manner. This results in a laterally varying absorption and a laterally varying phase front. Accordingly, the laser radiation can have a lateral interference pattern. This effect takes place when using laser pulses having a pulse duration of less than 20 ps even if the laser beam is guided continuously over the surface to be processed, since in the case of typical or currently technically implementable advancement speeds, the laser beam moves at most by a distance that is considerably smaller than the wavelength of the laser beam.

The article by M. Zukamoto et al., Journal of Physics: Conference Series 59 (2007), pages 666-669, also states that this phenomenon can be more pronounced and have a negative effect on the surface quality if several of the highly coherent laser pulses superpose one another in short local and temporal intervals, as in the case of surface patterning, cutting and drilling. It has been found in this context that such structures form even if the individual laser pulses do not exactly strike the same spot. The reason for this is that the structures made by a first pulse change the lateral absorption of the subsequent pulse and also result in increased speckle formation of the incoming radiation due to interference with the partially diffused reflected radiation (laterally varying absorption between successive pulses due to different structures and during a pulse on account of varying plasmon polariton interaction, and speckle formation within a pulse). The structure on the work piece surface can become further pronounced in this way.

### SUMMARY OF THE INVENTION

The invention is therefore based on the object of providing a method for processing a work piece using a pulsed laser beam, with which the occurrence of such microstructures can be either largely prevented or can be influenced according to the desired process result. The invention is additionally based on the object of specifying a laser assembly that is operated according to the method.

With respect to the method, the object is achieved according to the invention by way of a method having the features of the main method patent claim. According to these features, the lateral distribution of the spectral phase within the time duration of a laser pulse and/or at least between two laser pulses that overlap at least partially on the work piece is varied nonlinearly during the processing.

According to the invention, a variation of the lateral distribution of the spectral phase thus occurs during the time duration of a single laser pulse, or in addition or alternatively, the lateral distribution of the spectral phase, present in the laser pulses that follow one another in terms of time and superpose one another at least partially on the work piece, is changed such that no variation of the lateral distribution occurs within an individual laser pulse, but it is ensured that not all laser pulses used for processing, which superpose one another on the work piece, have the same lateral distribution of the spectral phase. In the latter case, it is also not absolutely necessary that all laser pulses which at least partially superpose one another differ with respect to their lateral distribution of the spectral phase. In principle, it is possible for two or more at least partially superposed laser pulses to have the same lateral distribution of the spectral phase if the processing process is such that a large number of laser pulses overlap at least partially, as in the case of percussion drilling, for example. In principle, however, it is advantageous, in particular for percussion drilling or for laser processing using a very large overlap of laser pulses that immediately follow one another in terms of time, if the lateral distribution of the spectral phase is varied between two immediately successive and superposed laser pulses. In the case of removal in a multi pass method (several at least partially superposed tracks), the laser pulses that immediately follow one another in terms of time and are located in one track also superpose one another. However, in this case it is possible in principle for all laser pulses of a track to have the same lateral distribution of the spectral phase, and for a variation to take place only in the case of a track change, wherein this does not even have to be the case for each track change.

The invention is here based on the consideration that the lateral distribution of the spectral phase or the phase spectrum of the ultra short laser pulses influences the coherence of the incoming laser beams or laser beam components with the reflected laser beams or laser beam components within a pulse and thus the occurrence and the form of the microstructures or nano-ripples. Accordingly, it is possible for the extent of the occurrence and the shape of such nano-ripples to be influenced even only by varying the spectral phase within the pulse or time duration of a laser pulse. If, in addition or alternatively, a nonlinear variation of the lateral distribution of the spectral phase at least between at least partially overlapping laser pulses that follow one another in terms of time takes place, the formation of undesired pronounced structures, in particular in so-called multi pass methods, described by Zukamoto et al. and caused by cumulative effects, is largely avoided. In this way, high-quality removal results can be achieved with surface properties which are optimally matched to the respective requirements, depending on the case of application for example large or small roughness.

An adjustment of this type can be effected for example by varying the pulse energy or by selecting the optical media in the beam path that interact nonlinearly with the laser beam so as to produce the surface quality that is desired for the respectively intended application in the case of correspondingly specified process parameters. Moreover, such adjustment can also be effected by inserting into the beam path optical components with which the lateral distribution of the nonlinear spectral phase within a laser pulse or between successive laser pulses can be selectively controlled, for example by broadening or narrowing the laser beam upstream of an optical medium that interacts with the laser beam nonlinearly and/or use of an optical medium, arranged so as to be adjustable laterally, i.e. transversely to the beam axis, with laterally varying nonlinear refractive index.

Occurrence of such nano-ripples can be reduced in particular if the variation of the lateral distribution of the spectral phase is effected by varying the lateral distribution of the B integral.

The B integral or the B integral value is defined by the relationship

$$B ( z , r ) = \frac{2 π}{λ} \int {n}_{2} l ( z , r ) d z ,$$

wherein z is the distance traveled by the laser beam along the beam axis (central axis), I is the peak intensity of the laser beam as a function of the distance traveled along the beam axis z and the lateral distance r from the beam axis z, and n₂ is the Kerr coefficient or the nonlinear proportion of the refractive index (referred to below in short as nonlinear refractive index), which is generally likewise a function of z and r. The B integral value at a lateral point r of the laser beam after propagation of the laser pulse through an optical medium along a path z is proportional to the distance traveled and the respectively present peak intensity. The B integral is thus a measure of the nonlinear interaction of a laser pulse with an optical medium and is a measure of the accumulated self-phase modulation. Since the pulse duration and pulse form at a point of the beam cross section depend on the spectral phase that is present there, a laterally varying B integral corresponds to a pulse duration and pulse form that vary over the beam cross section.

To reduce the intensity-dependent modulation of the spectral phase, it is known for example from U.S. Pat. No. 6,141,362 in principle to take measures to achieve a minimum B integral that is as constant as possible over the entire beam cross section. This is affected by placing a semiconductor material in the beam path of the laser, which semiconductor material has a negative nonlinear refractive index and in this way produces a negative B integral with which the positive B integral produced by a laser amplifier that is arranged in the beam path is compensated.

In deviation from the measures suggested there, the invention takes a different approach, specifically by selectively setting the B integral to values that differ relative to one another over the beam cross section so as to influence the coherence of incoming and reflected laser beams in this way and to reduce the structure contrast on the surface by averaging over many irradiation occurrences with a radially and temporally varying B integral.

In one preferred embodiment of the method, using a laser beam the laser pulses of which have a pulse duration that is less than 20 ps, the spectral phase of the laser pulses is set such that the B integral of the laser pulse upon striking the work piece varies transversely to the beam axis, i.e. is not constant and assumes values between −50 rad and +50 rad, wherein in particular for pulse durations of less than 10 ps, B integral values of between −20 rad and +20 rad are set and for pulse durations of less than 2 ps B integral values of between −5 rad and +5 rad are set.

By setting the B integral in this way, nano-ripples can be largely avoided or the extent to which they are pronounced can be reduced, since in this case the coherence of the laser radiation is influenced and the structure formation is additionally reduced by the averaging over a plurality of pulses with different radially and temporally varying spectral phases.

The lateral distribution of the spectral phase of immediately successive laser pulses is varied in particular in the case of percussion drilling, wherein in principle the lateral distributions of the spectral phase of all laser pulses can differ from one another, i.e. each laser pulse can have a different lateral distribution of the spectral phase.

In the case of laser ablation in a multi pass method, in which the laser beam is moved several times along overlapping tracks, it may be sufficient if the lateral distribution of the spectral phase is varied only in the case of a track change, such that each track can be produced with laser pulses that have the same lateral distribution of the spectral phase within this track.

The occurrence of such an undesired surface structure can additionally be reduced if the overlap of the incoming laser pulses is additionally varied.

In one preferred exemplary embodiment, this setting of the spectral phase is affected by broadening or narrowing the laser beam upstream of at least one optical medium arranged in the beam path which interacts nonlinearly with a laser beam.

With respect to the laser assembly, the object is achieved by way of the features of the main device patent claim. By providing a device, in particular a controllable beam shaping device, for varying the lateral distribution of the spectral phase of the laser pulses, it is possible to optimize the processing process in respect of the respectively specific requirements.

Alternatively or additionally, a device for nonlinear variation contains an optical medium that is arranged to be adjustable transversely to the beam axis with a laterally varying, nonlinear refractive index, optical components which are configured for broadening or narrowing the laser beam upstream of a medium that interacts with the laser beam nonlinearly, a correspondingly configured control unit for controlling the pulse energy or the peak intensity, and/or optical media the nonlinear refractive index of which varies transversely to the beam axis, for example due to dopants. It is to be understood that combinations of the above-mentioned devices are also envisaged in accordance with alternative exemplary embodiments.

Other features which are considered as characteristic for the invention are set forth in the appended claims.

Although the invention is illustrated and described herein as embodied in a method and a laser assembly for processing a work piece using a pulsed laser beam, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1 to 3 are schematic diagrams showing laser assemblies for carrying out the method according to the invention.

### DETAILED DESCRIPTION OF THE INVENTION

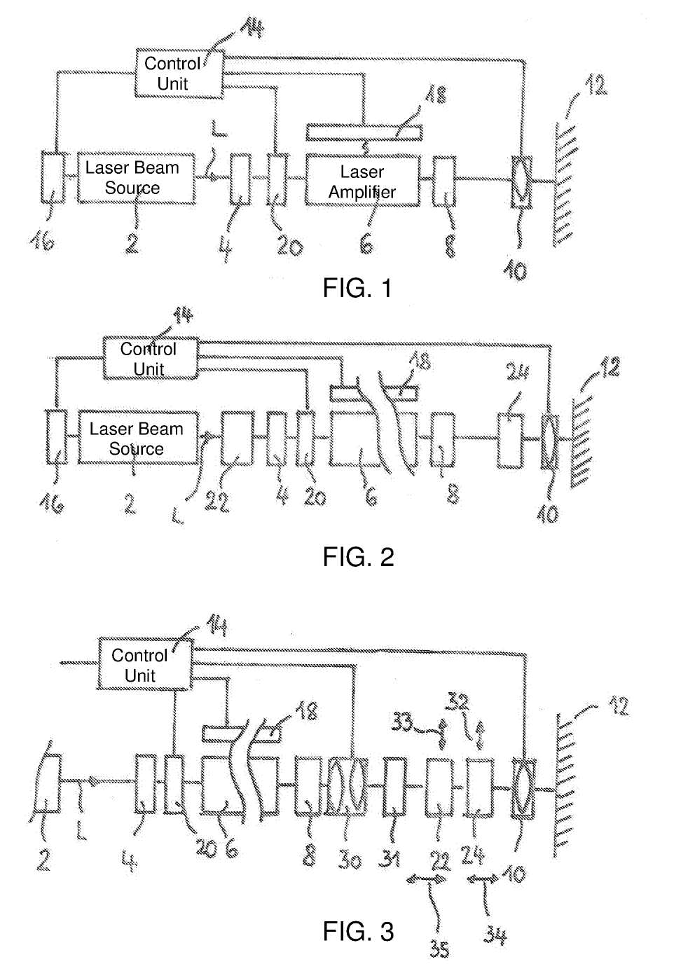

Referring now to the figures of the drawings in detail and first, particularly to FIG. 1 thereof, there is shown a laser assembly according to the invention which has a laser beam source 2 for generating a pulsed laser beam L consisting of a temporal sequence of ultra short laser pulses. In order to avoid uncontrolled or too pronounced nonlinear modulation of the spectral phase or optical destruction of the optical components located in the transmission chain, the laser pulses exiting the laser beam source 2 are broadened in the time domain in a stretcher 4 such that the maximum intensity in the laser pulse is reduced due to such an increase in pulse duration. The stretcher 4 can be a free-beam grating arrangement or a different arrangement made up of different dispersive optical elements. The laser pulse which has been temporally stretched in this manner is amplified in a laser amplifier 6. The amplified laser pulse is subsequently compressed again in the time domain in an optical compressor 8 in order to generate in this way a laser pulse having a pulse duration of less than 20 ps, preferably less than 10 ps and in particular less than 2 ps. The laser beam that is generated is guided to a focusing, beam-shaping and deflection unit 10, which is illustrated symbolically in the figure by way of a lens. The laser pulse thus focused impinges on a work piece 12 and effects here the material removal with low heat input by way of evaporating the material without producing a melt zone worth mentioning.

Owing to the very small pulse duration and the required energy input for the removal per laser pulse, which can be a few 100 nJ to a few mJ (fine processing in the μm range) depending on the application, a very high peak intensity is present in the laser pulse, at which a nonlinear interaction of the laser beam with the optical media present in the transmission chain can occur which results in nonlinear modulation of the spectral phase, i.e. of the phase spectrum of the laser beam pulse. The extent of this nonlinear modulation of the spectral phase is here dependent on the peak intensity present in the laser pulse, and can accordingly be influenced by varying the peak intensity.

In order to vary the peak intensity and, accordingly, to vary the spectral phase, a control unit 14 for controlling the pump sources 16, 18 used for optically pumping the laser beam source 2 and the laser amplifier 6 and a pulse picker 20 arranged upstream of the laser amplifier 6 and generally the stretcher 4 is provided. Depending on the amplifier medium used in the laser amplifier 6, variation of the beam cross section in the amplifier medium is also possible in principle. The pulse energy and thus the peak intensity are generally varied and adjusted by controlling the pump power of the pump source 18 associated with the amplifier 6 and by controlling the pulse picker 20. By controlling or setting the pulse energy or peak intensity, it is accordingly possible for the variation of the lateral distribution of the nonlinear spectral phase either to be matched once to the process result or process target to be respectively achieved, or to be varied alternatively or additionally from laser pulse to laser pulse in order to avoid the above-mentioned cumulative effect that occurs when carrying out a multi pass method or in the case of percussion drilling and that results in the formation of structures. It is additionally possible to control the focusing, beam shaping and deflection unit 10 using the control unit 14 such that, for example, the overlap of the laser pulses striking the same point can be varied.

In the exemplary embodiment according to FIG. 2, optical media 22, 24 having different nonlinear refractive indices are arranged in the transmission path, for example upstream of the stretcher 4 and downstream of the compressor 8. The optical medium 22 has a negative nonlinear refractive index and the optical medium 24 has a positive nonlinear refractive index. By combining such optical media having positive and negative linear refractive indices, it is possible to selectively adjust the respectively desired values for the B integral. Alternatively to the arrangement shown in FIG. 2, the optical media 22, 24 can also be arranged directly one behind the other and form a structural unit. In this case, both optical media 22, 24 are arranged, when viewed in the propagation direction of the laser beam, either upstream of the stretcher 4 or downstream of the amplifier 6 or downstream of the compressor 8.

In the exemplary embodiment according to FIG. 3, a beam-shaping device 30 that is controllable by the control unit 14 for variable beam shaping, in particular beam broadening or beam narrowing, is arranged downstream of the compressor 8 and upstream of the optical media 22, 24, with which beam-shaping device 30 the peak intensity of the laser pulse can likewise be varied. Alternatively to the embodiment illustrated in FIG. 3, the device 30 can additionally be arranged between the optical media 22, 24. The beam-shaping device 30 and optical media 22, 24 can likewise form a structural unit that can be arranged either upstream of the stretcher 4 or downstream of the amplifier 6. It is possible with such an arrangement to vary the nonlinear spectral phase without needing to interchange optical components.

Alternatively to the possibility of varying the nonlinear spectral phase with an unchanging construction, illustrated in FIG. 3, the use of an optical medium, the nonlinear refractive index n₂ of which varies transversely to the beam axis (central axis of the laser beam L), for example due to do pants, streaks or the assembly of an optical element from many segments, is also possible. By variable beam shaping and/or varying the polarization of the laser radiation using a retardation plate 31 that is connected upstream of the optical media 22, 24 or the optical media, for example polycrystalline solid body, and/or varying the location of the beam axis in the optical medium by moving the medium transversely to the beam axis, or varying the beam cross section upon entry into the medium by way of moving the medium parallel to the beam axis, the lateral B integral distribution can be dynamically modulated. This transverse and length displacement is indicated in FIG. 3 by way of double-headed arrows 32, 33 and 34, 35, respectively.

The invention is not limited to the embodiments illustrated in the figures. Embodiments that do not use stretchers, compressors or laser amplifiers are also possible in principle.

1. A method for processing a work piece, which comprises the steps of:
providing a pulsed laser beam, in the pulsed laser beam a lateral distribution of a spectral phase within a time duration is varied nonlinearly during a processing over a beam cross section of a laser pulse and/or at least between two laser pulses that overlap at least partially on the work piece.

2. The method according to claim 1, which further comprises effecting a variation of the lateral distribution of the spectral phase by varying the lateral distribution of a B integral.

3. The method according to claim 2, which further comprises setting a pulse duration to be less than 20 ps and in which the spectral phase is adjusted such that the B integral of the laser pulse when striking the work piece varies transversely to a beam axis and assumes values of between −50 rad and +50 rad.

4. The method according to claim 2, which further comprises setting a pulse duration to be less than 10 ps and in which the spectral phase is adjusted such that the B integral of the laser pulse when striking the work piece varies transversely to a beam axis and assumes values of between −20 rad and +20 rad.

5. The method according to claim 2, which further comprises setting a pulse duration to be less than 2 ps and in which the spectral phase is adjusted such that the B integral of the laser pulse when striking the work piece varies transversely to a beam axis and assumes values of between −5 rad and +5 rad.

6. The method according to claim 1, wherein the laser pulses that immediately follow one another in terms of time have different lateral distributions of the spectral phase.

7. The method according to claim 1, which further comprises effecting the processing of the work piece in a multipass method with several overlapping tracks, and in which the laser pulses of the overlapping tracks that follow one another in terms of time have different lateral distributions of the spectral phase.

8. The method according to claim 1, which further comprises varying an overlap of the laser pulses.

9. The method according to claim 1, which further comprises effecting a variation of the lateral distribution of the spectral phase by broadening or narrowing the pulsed laser beam upstream of at least one optical medium that is disposed in a beam path and interacts nonlinearly with the laser pulses.

10. A laser assembly, comprising:
a laser beam source for generating a laser beam being present in a form of laser pulses;
at least one optical medium disposed in a beam path of the laser beam and interacting nonlinearly with the laser pulses; and
means for nonlinear variation of a lateral distribution of a spectral phase over a beam cross section of the laser pulses.

11. The laser assembly according to claim 10, further comprising a controllable beam-shaping device for adjusting the lateral distribution of the spectral phase of the laser pulses.

12. The laser assembly according to claim 10, further comprising a retardation plate connected upstream of said at least one optical medium for varying the lateral distribution of the spectral phase of the laser pulses.

13. The laser assembly according to claim 10, wherein a nonlinear refractive index of said at least one optical medium varies transversely to a beam axis.

14. The laser assembly according to claim 10, wherein said at least one optical medium is disposed to be displaceable transversely and/or parallel to a central axis of the laser beam.
